(19) United States
(12) Patent Application Publication
(10) Pub. No.: US 2016/0168462 A1
(43) Pub. Date: Jun. 16, 2016

(54) NEMATIC LIQUID CRYSTAL COMPOSITION AND LIQUID CRYSTAL DISPLAY DEVICE INCLUDING THE SAME

(71) Applicant: DIC Corporation, Tokyo (JP)

(72) Inventors: Go Sudo, Kita-adachi-gun (JP); Shotaro Kawakami, Kita-adachi-gun (JP)

(73) Assignee: DIC CORPORATION, Tokyo (JP)

(21) Appl. No.: 14/436,644

(22) PCT Filed: Oct. 21, 2013
(86) PCT No.: PCT/JP2013/078439

§ 371 Date: Apr. 17, 2015

(30) Foreign Application Priority Data
Oct. 24, 2012 (JP) 2012-234705
Oct. 29, 2012 (JP) 2012-237809

(51) Int. Cl. C09K 19/30; C09K 19/54; C09K 19/02

(52) U.S. Cl. CPC C09K 19/3066; C09K 19/3003; C09K 19/0216; C09K 19/542; C09K 2019/3004; C09K 2019/3009; C09K 2019/301; C09K 2019/3016; C09K 2019/548

(57) ABSTRACT

The present invention relates to nematic liquid crystal compositions having a negative dielectric anisotropy (Δ∈) and useful as liquid crystal display materials and to liquid crystal display devices including such liquid crystal compositions. The present invention provides a liquid crystal composition with sufficiently low viscosity (η), sufficiently low rotational viscosity (γ₁), high elastic constant (K₃₃), and a dielectric anisotropy (Δ∈) large in absolute value without decreasing the refractive index anisotropy (Δn) or nematic-isotropic liquid phase transition temperature (Tₙᵢ) thereof. A liquid crystal display device including such a liquid crystal composition has high response speed and good display quality with few or no display defects. The liquid crystal display device is particularly useful as an active-matrix liquid crystal display device. The liquid crystal display device is applicable to display modes such as the VA mode and the PSVA mode.

### TECHNICAL FIELD

The present invention relates to nematic liquid crystal compositions having a negative dielectric anisotropy (Δ∈) and useful as liquid crystal display materials and to liquid crystal display devices including such liquid crystal compositions.

### BACKGROUND ART

Liquid crystal display devices are used in equipment such as clocks, calculators, various household electric appliances, measuring instruments, automotive panels, word processors, electronic organizers, printers, computers, and televisions. Typical liquid crystal display modes include the twisted nematic (TN) mode, the super-twisted nematic (STN) mode, the dynamic scattering (DS) mode, the guest-host (GH) mode, the in-plane switching (IPS) mode, the optically compensated bend (OCB) mode, the electrically controlled birefringence (ECB) mode, the vertical alignment (VA) mode, the color super-homeotropic (CSH) mode, and the ferroelectric liquid crystal (FLC) mode. Example addressing schemes include static addressing, multiplex addressing, simple matrix addressing, and active matrix (AM) addressing based on devices such as thin-film transistors (TFTs) and thin-film diodes (TFDs).

Some display modes, such as the IPS mode, the ECB mode, the VA mode, and the CSH mode, are characterized by the use of liquid crystal materials having a negative Δ∈. In particular, the VA mode, which is implemented by AM addressing, is used for display device applications requiring quick response and a wide viewing angle, such as televisions.

Nematic liquid crystal compositions, which are used for display modes such as the VA mode, require low operating voltage, quick response, and a wide operating temperature range. Specifically, nematic liquid crystal compositions require a negative Δ∈ large in absolute value, low viscosity, and high nematic-isotropic liquid phase transition temperature (Tₙᵢ). The refractive index anisotropy (Δn) of liquid crystal materials also needs to be adjusted to an appropriate range depending on the cell gap (d), taking into account the product of Δn and the cell gap, i.e., Δn×d. Liquid crystal materials also require low viscosity (η) for use in applications where quick response is important, such as televisions.

To improve the properties of liquid crystal compositions, various compounds having a negative Δ∈ large in absolute value have so far been researched.

As an example of a liquid crystal material having a negative Δ∈, a liquid crystal composition has been disclosed that contains the following liquid crystal compounds (A) and (B) having a 2,3-difluorophenylene backbone (see PTL 1):

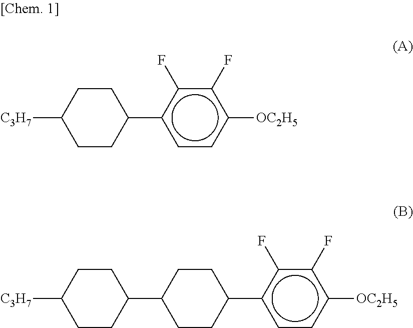

This liquid crystal composition contains the liquid crystal compounds (C) and (D), which have a Δ∈ of substantially zero. Unfortunately, this liquid crystal composition has insufficiently low viscosity for use in applications requiring quick response, such as liquid crystal televisions.

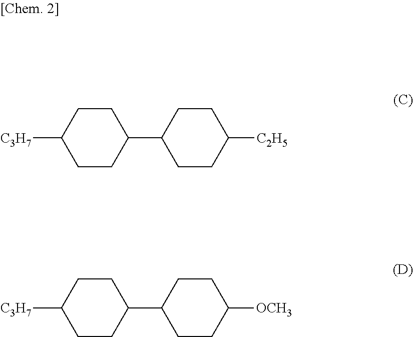

Liquid crystal compositions containing the compound represented by formula (E) have also been disclosed, including one containing the above liquid crystal compound (D) and having low Δn (see PTL 2) and one containing a compound having an alkenyl group in the molecule thereof (i.e., an alkenyl compound), such as the liquid crystal compound (F), to achieve a higher response speed (see PTL 3). Unfortunately, these liquid crystal compositions require further research to achieve both high Δn and high reliability.

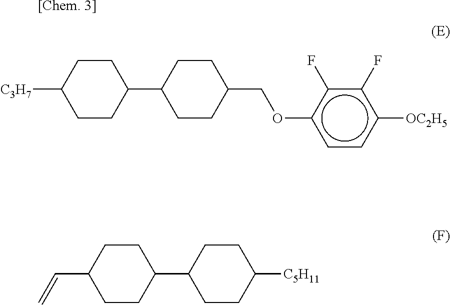

A liquid crystal composition containing the compound represented by formula (G) has also been disclosed (see PTL 4). Again, this liquid crystal composition contains an alkenyl compound like the above liquid crystal compound (F) and thus tends to suffer display defects such as burn-in and unevenness.

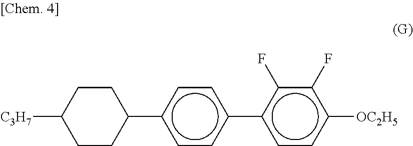

The influence of liquid crystal compositions containing alkenyl compounds on display defects has been disclosed (see PTL 5). A liquid crystal composition containing a smaller amount of alkenyl compound generally has a higher η, which makes it difficult to achieve quick response. This means that it is difficult to achieve both fewer display defects and quick response.

As discussed above, it is difficult to provide a liquid crystal composition with a negative Δ∈ that has both high Δn and low η and that suffers few or no display defects simply by combining compounds having a negative Δ∈ with the liquid crystal compounds (C), (D), and (F).

A liquid crystal composition has also been disclosed that contains the compounds of formulae (A) and (G) in combination with the compound of formula (III-F31), which has a Δ∈ of substantially zero (see PTL 6). It has been thought that the amount of compound of formula (III-F31) cannot be increased because compounds having low vapor pressures evaporate at extremely low pressures during the injection of liquid crystal compositions into liquid crystal cells in the manufacture of liquid crystal display devices. Thus, the amount of compound of formula (III-F31) in the liquid crystal composition is limited. Although the liquid crystal composition has high Δn, it has significantly high viscosity.

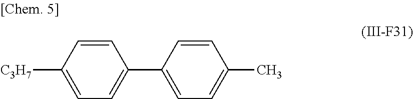

PTLs 6 and 7 disclose liquid crystal compositions containing compounds having a fluorine-substituted terphenyl structure.

PTL 8 discloses the use of a liquid crystal material having a high factor represented by equation (1) to provide a homeotropic liquid crystal cell with a higher response speed. Unfortunately, this technique is insufficient.

[Math. 1]

FoM=K₃₃·Δn²/γ₁ (1)

K₃₃: elastic constant

Δn: refractive index anisotropy

γ₁: rotational viscosity

Accordingly, there is a need to provide a liquid crystal composition with sufficiently low viscosity (η), sufficiently low rotational viscosity (γ₁), and high elastic constant (K₃₃) for use in applications requiring quick response, such as liquid crystal televisions, without decreasing the refractive index anisotropy (Δn) or nematic-isotropic liquid phase transition temperature (Tₙᵢ) thereof.

### CITATION LIST

### Patent Literature

PTL 1: Japanese Unexamined Patent Application Publication No. 8-104869

PTL 2: European Patent Application Publication No. 0474062

PTL 3: Japanese Unexamined Patent Application Publication No. 2006-37054

PTL 4: Japanese Unexamined Patent Application Publication No. 2001-354967

PTL 5: Japanese Unexamined Patent Application Publication No. 2008-144135

PTL 6: WO2007/077872

PTL 7: Japanese Unexamined Patent Application Publication No. 2003-327965

PTL 8: Japanese Unexamined Patent Application Publication No. 2006-301643

### SUMMARY OF INVENTION

### Technical Problem

An object of the present invention is to provide a liquid crystal composition with sufficiently low viscosity (η), sufficiently low rotational viscosity (γ₁), high elastic constant (K₃₃), and a negative dielectric anisotropy (Δ∈) large in absolute value without decreasing the refractive index anisotropy (Δn) or nematic-isotropic liquid phase transition temperature (Tₙᵢ) thereof, and to provide a liquid crystal display device, such as a VA-mode liquid crystal display device, including such a liquid crystal composition and having high response speed and good display quality with few or no display defects.

### Solution to Problem

The inventors have researched various biphenyls and fluorobenzenes and have found that the foregoing object can be achieved by the use of a combination of particular compounds, which has led to the present invention.

The present invention provides a liquid crystal composition containing a first component and a second component. The first component is at least one compound represented by general formula (I):

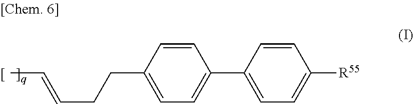

(where q is 0 or 1, and R⁵⁵ is an alkyl group having 1 to 10 carbon atoms or an alkenyl group having 2 to 10 carbon atoms). The first component is present in an amount of 3% to 25% by mass. The second component is a compound having a negative dielectric anisotropy (Δ∈) larger than 3 in absolute value. The present invention also provides a liquid crystal display device including such a liquid crystal composition.

### Advantageous Effects of Invention

The present invention provides a liquid crystal composition with sufficiently low viscosity (η), sufficiently low rotational viscosity (γ₁), high elastic constant (K₃₃), and a negative dielectric anisotropy (Δ∈) large in absolute value without decreasing the refractive index anisotropy (Δn) or nematic-isotropic liquid phase transition temperature (Tₙᵢ) thereof. A liquid crystal display device, such as a VA-mode liquid crystal display device, including such a liquid crystal composition has high response speed and good display quality with few or no display defects.

### DESCRIPTION OF EMBODIMENTS

A liquid crystal composition according to the present invention contains a first component. The first component is a compound represented by general formula (I). The first component is present in an amount of 3% to 25% by mass, preferably 5% to 20% by mass, more preferably 5% to 15% by mass. More specifically, the first component is preferably present in an amount of 10% to 25% by mass to achieve high Δn and is preferably present in an amount of 3% to 15% by mass to inhibit low-temperature precipitation more effectively.

In general formula (I), R⁵⁵ is an alkyl group having 1 to 10 carbon atoms or an alkenyl group having 2 to 10 carbon atoms, preferably an alkyl group having 2 to 5 carbon atoms or an alkenyl group having 2 to 5 carbon atoms.

In general formula (I), q is 0 or 1.

Specifically, the compound of general formula (I) preferably has any of formulae (I-A1), (I-A2), (I-A3), (I-A4), (I-A5), (I-B1), (I-B2), (I-B3), (I-B4), (I-B5), and (I-B6).

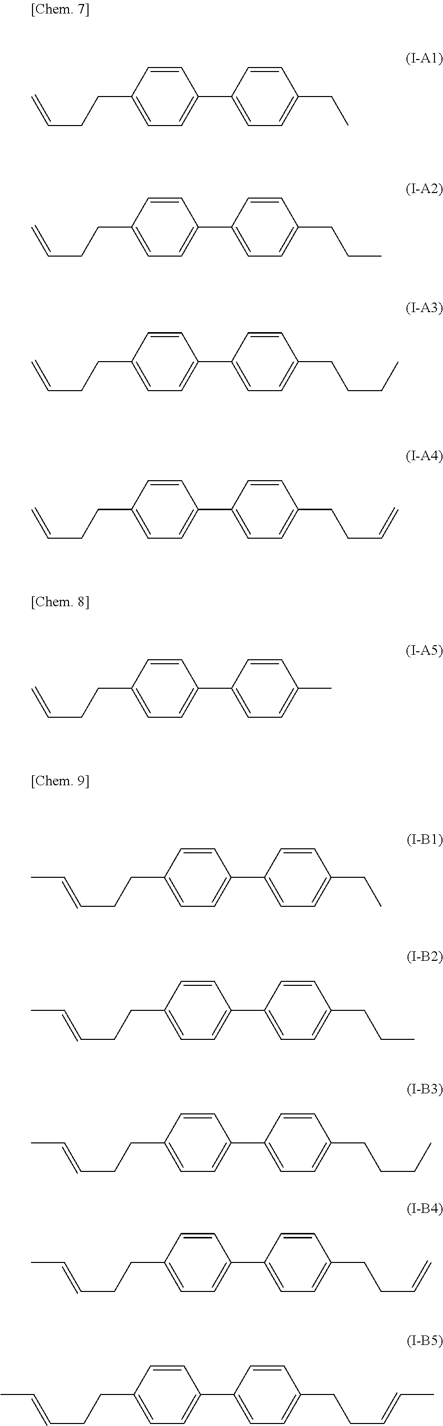

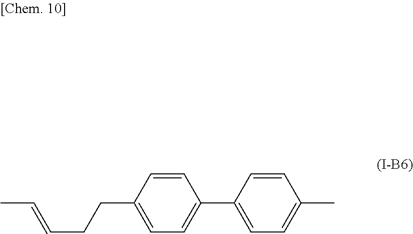

For reasons of viscosity, the compound of general formula (I) preferably has formula (I-A1), (I-A5), (I-B1), or (I-B6). For reasons of elastic constant, the compound of general formula (I) preferably has formula (I-A4), (I-B4), or (I-B5).

The liquid crystal composition according to the present invention preferably contains two or more compounds of general formula (I). More preferably, the liquid crystal composition according to the present invention simultaneously contains two or more of the compounds of formulae (I-A4), (I-B4), and (I-B5).

The liquid crystal composition according to the present invention further contains a second component. The second component is at least one compound having a negative dielectric anisotropy (Δ∈) larger than 3 in absolute value. The second component is preferably present in an amount of 10% to 90% by mass, more 20% to 80% by mass, even more preferably 30% to 70% by mass.

Specifically, the second component is preferably a compound represented by general formula (II):

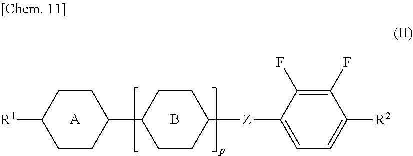

(where R¹ and R² are each independently an alkyl group having 1 to 10 carbon atoms, an alkoxyl group having 1 to 10 carbon atoms, an alkenyl group having 2 to 10 carbon atoms, or an alkenyloxy group having 2 to 10 carbon atoms, where one or more separate —CH₂— groups present in R¹ and R² are each independently optionally replaced by —O— and/or —S—, and one or more hydrogen atoms present in R¹ and R² are each independently optionally replaced by a fluorine atom or a chlorine atom; rings A and B are each independently trans-1,4-cyclohexylene, 1,4-phenylene, 2-fluoro-1,4-phenylene, 3-fluoro-1,4-phenylene, 3,5-difluoro-1,4-phenylene, 2,3-difluoro-1,4-phenylene, 1,4-cyclohexenylene, 1,4-bicyclo[2.2.2]octylene, piperidine-1,4-diyl, naphthalene-2,6-diyl, decahydronaphthalene-2,6-diyl, or 1,2,3,4-tetrahydronaphthalene-2,6-diyl; p is 0, 1, or 2; and Z is —OCH₂—, —CH₂O—, —CF₂O—, —OCF₂—, —CH₂CH₂—, —CF₂CF₂—, or a single bond).

Preferably, R¹ and R² in the formula are each independently a linear alkyl group having 1 to 5 carbon atoms, an alkoxyl group having 1 to 5 carbon atoms, an alkenyl group having 2 to 5 carbon atoms, or an alkenyloxy group having 2 to 5 carbon atoms. More preferably, R¹ is an alkyl group having 1 to 5 carbon atoms or an alkenyl group having 2 to 5 carbon atoms, and R² is an alkoxyl group having 1 to 5 carbon atoms.

Preferably, rings A and B in the formula are each independently trans-1,4-cyclohexylene, 1,4-phenylene, 2-fluoro-1,4-phenylene, 3-fluoro-1,4-phenylene, 3,5-difluoro-1,4-phenylene, or 2,3-difluoro-1,4-phenylene, more preferably trans-1,4-cyclohexylene or 1,4-phenylene.

Preferably, p in the formula is each independently 0 or 1.

Preferably, z in the formula is —CH₂O—, —CF₂O—, or a single bond, more preferably —CH₂O— or a single bond.

The liquid crystal composition according to the present invention contains one or more second components, preferably two to ten second components.

The compound represented by general formula (II) is preferably selected from compounds represented by general formulae (II-A1) to (II-A5) and (II-B1) to (II-B5):

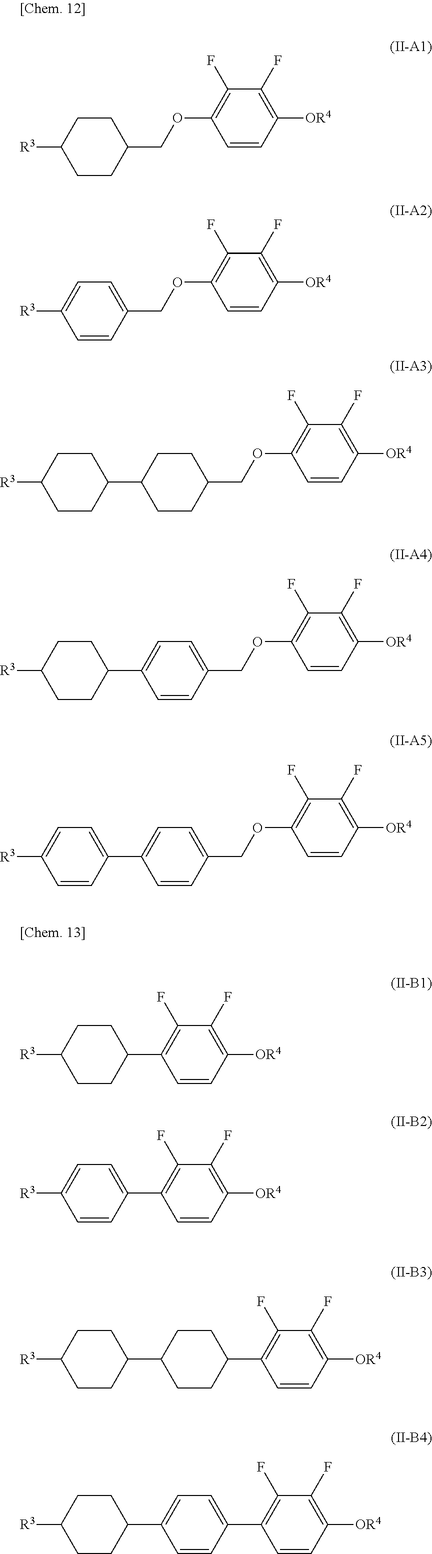

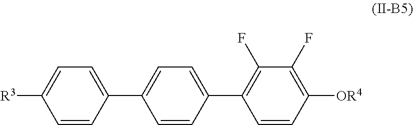

(where R³ and R⁴ are each independently an alkyl group having 1 to 5 carbon atoms or an alkenyl group having 2 to 5 carbon atoms, where one or more hydrogen atoms present in R³ and R⁴ are each independently optionally replaced by a fluorine atom), more preferably general formulae (II-A1) to (II-A5), even more preferably formulae (II-A1) or (II-A3).

The liquid crystal composition according to the present invention preferably further contains a third component. The third component is at least one compound selected from compounds represented by general formulae (III-A) to (III-J):

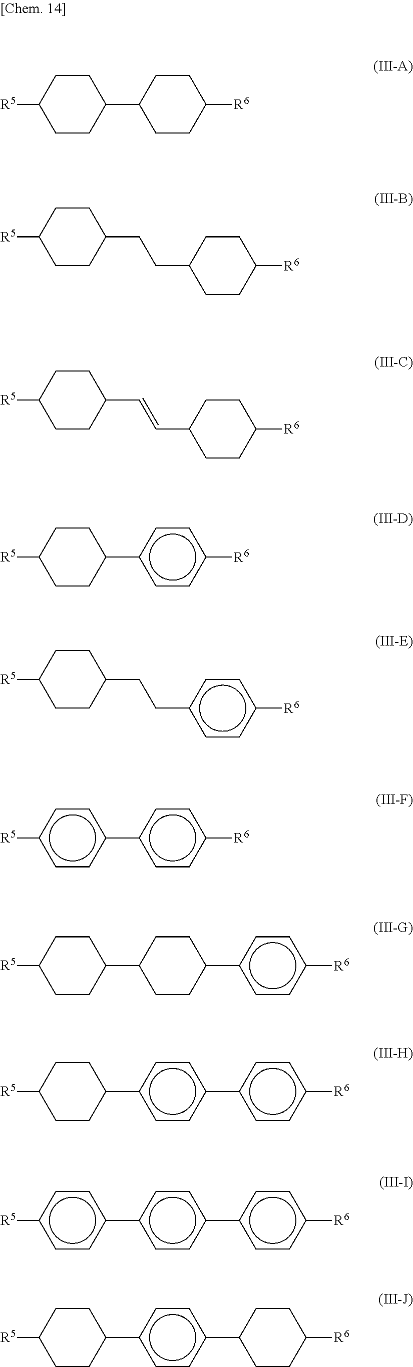

(where R⁵ is an alkyl group having 1 to 5 carbon atoms or an alkenyl group having 2 to 5 carbon atoms; and R⁶ is an alkyl group having 1 to 5 carbon atoms, an alkoxyl group having 1 to 5 carbon atoms, an alkenyl group having 2 to 5 carbon atoms, or an alkenyloxy group having 2 to 5 carbon atoms), where the compounds represented by general formula (III-F) exclude compounds represented by general formula (I).

Preferably, the third component is a compound selected from compounds of general formulae (III-A), (III-D), (III-F), (III-G), and (III-H). In preferred compounds represented by general formula (III-A), R⁵ is an alkenyl group having 2 to 5 carbon atoms, and R⁶ is an alkyl group having 1 to 5 carbon atoms or an alkenyl group having 2 to 5 carbon atoms.

The liquid crystal composition according to the present invention preferably further contains at least one compound represented by general formula (V):

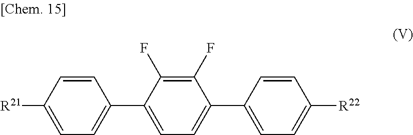

In the formula, R²¹ and R²² are each independently an alkyl group having 1 to 8 carbon atoms, an alkoxyl group having 1 to 8 carbon atoms, an alkenyl group having 2 to 8 carbon atoms, or an alkenyloxyl group having 2 to 8 carbon atoms, preferably an alkyl group having 1 to 5 carbon atoms or an alkenyl group having 2 to 5 carbon atoms.

The liquid crystal composition according to the present invention preferably simultaneously contains compounds of general formulae (I), (II-A1), and (III-A). The liquid crystal composition according to the present invention preferably simultaneously contains compounds of general formulae (I), (II-A3), and (III-A). The liquid crystal composition according to the present invention preferably simultaneously contains compounds of general formulae (I), (II-B1), and (III-A). The liquid crystal composition according to the present invention preferably simultaneously contains compounds of general formulae (I), (II-B2), and (III-A). The liquid crystal composition according to the present invention preferably simultaneously contains compounds of general formulae (I), (II-B3), and (III-A). The liquid crystal composition according to the present invention preferably simultaneously contains compounds of general formulae (I), (II-B4), and (III-A).

The liquid crystal composition according to the present invention more preferably simultaneously contains compounds of general formulae (I), (II-A1), (II-A3), and (III-A). The liquid crystal composition according to the present invention more preferably simultaneously contains compounds of general formulae (I), (II-B1), (II-B2), and (III-A). The liquid crystal composition according to the present invention more preferably simultaneously contains compounds of general formulae (I), (II-B1), (II-B3), and (III-A). The liquid crystal composition according to the present invention more preferably simultaneously contains compounds of general formulae (I), (II-B1), (II-B4), and (III-A). The liquid crystal composition according to the present invention more preferably simultaneously contains compounds of general formulae (I), (II-B2), (II-B3), and (III-A). The liquid crystal composition according to the present invention more preferably simultaneously contains compounds of general formulae (I), (II-B2), (II-B4), and (III-A).

Also preferably, the liquid crystal composition according to the present invention simultaneously contains compounds of formulae (I-A4) and (I-B5) and general formula (η). More preferably, the liquid crystal composition according to the present invention simultaneously contains compounds of formulae (I-A4) and (I-B5) and general formulae (η) and (III-A), even more preferably compounds of formulae (I-A4) and (I-B5) and general formulae (η), (III-A), and (V).

The liquid crystal composition according to the present invention has a dielectric anisotropy (Δ∈) at 25° C. of −2.0 to −8.0, preferably −2.0 to −6.0, more preferably −2.0 to −5.0, even more preferably −2.5 to −4.0.

The liquid crystal composition according to the present invention has a refractive index anisotropy (Δn) at 20° C. of 0.08 to 0.14, preferably 0.09 to 0.13, more preferably 0.09 to 0.12. More specifically, the liquid crystal composition according to the present invention preferably has a refractive index anisotropy (Δn) at 20° C. of 0.10 to 0.13 for thin cell gaps and preferably has a refractive index anisotropy (Δn) at 20° C. of 0.08 to 0.10 for thick cell gaps.

The liquid crystal composition according to the present invention has a viscosity (η) at 20° C. of 10 to 30 mPa·s, preferably 10 to 25 mPa·s, more preferably 10 to 22 mPa·s.

The liquid crystal composition according to the present invention has a rotational viscosity (γ₁) at 20° C. of 60 to 130 mPa·s, preferably 60 to 110 mPa·s, more preferably 60 to 100 mPa·s.

The liquid crystal composition according to the present invention has a nematic-isotropic liquid phase transition temperature (Tₙᵢ) of 60° C. to 120° C., preferably 70° C. to 100° C., more preferably 70° C. to 85° C.

The liquid crystal composition according to the present invention may further contain other components such as common nematic liquid crystals, smectic liquid crystals, cholesteric liquid crystals, antioxidants, ultraviolet absorbers, and polymerizable monomers.

For example, polymerizable compounds such as biphenyls and terphenyls may be present as polymerizable monomers in an amount of 0.01% to 2% by mass. More specifically, the liquid crystal composition according to the present invention preferably contains a polymerizable compound represented by general formula (IV):

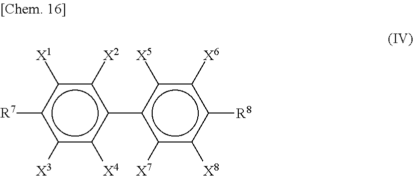

The liquid crystal composition according to the present invention preferably contains one or more such compounds.

In the formula, R⁷ and R⁸ are each independently represented by any of formulae (R-1) to (R-15):

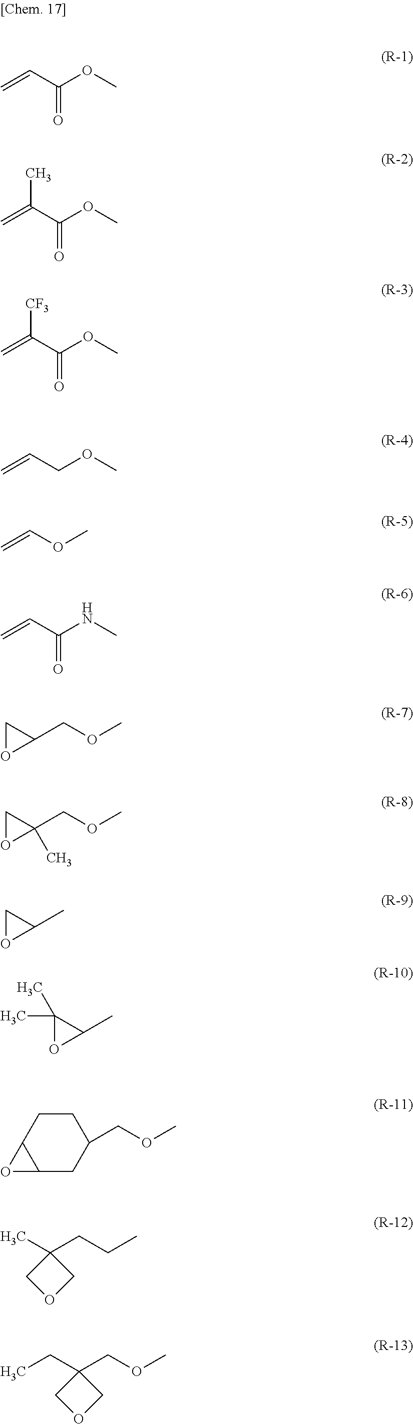

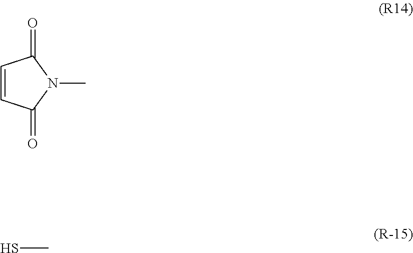

In the formula, X¹ to X⁸ are each independently trifluoromethyl, trifluoromethoxy, fluorine, or hydrogen.

The biphenyl backbone in general formula (IV) preferably has any of formulae (IV-11) to (IV-14), more preferably formula (IV-11):

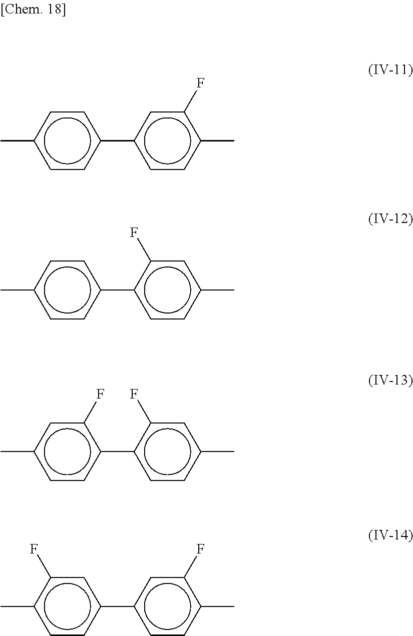

Polymerizable compounds containing the backbones represented by formulae (IV-11) to (IV-14) have the optimum anchoring strength after polymerization, which contributes to good alignment.

A polymerizable-compound containing liquid crystal composition containing a polymerizable compound of general formula (IV) according to the present invention has low viscosity (η), low rotational viscosity (γ₁), and high elastic constant (K₃₃). A PSA-mode or PSVA-mode liquid crystal display device including such a liquid crystal composition is capable of quick response.

A liquid crystal display device including the liquid crystal composition according to the present invention, which has the significant advantage of quick response, is particularly useful as an active-matrix liquid crystal display device and is applicable to the VA mode, the PSVA mode, the PSA mode, the IPS mode, and the ECB mode.

### EXAMPLES

The present invention is further illustrated by the following examples, although these examples are not intended to limit the present invention. In the following examples and comparative examples, percentages are by mass.

In the examples, compounds are denoted by the following abbreviations:

### Side Chains

-n —CₙH₂ₙ₊₁: linear alkyl group having n carbon atoms

n- CₙH₂ₙ₊₁—: linear alkyl group having n carbon atoms

—On —OCₙH₂ₙ₊₁: linear alkoxyl group having n carbon atoms

nO— CₙH₂ₙ₊₁O—: linear alkoxyl group having n carbon atoms

—V —CH═CH₂

V— CH₂═CH—

—V1 —CH═CH—CH₃

1V— CH₂—CH═CH—

-2V —CH₂—CH₂—CH═CH₃

V2— CH₃═CH—CH₂—CH₂—

-2V1 —CH₂—CH₂—CH═CH—CH₃

1V2— CH₃—CH═CH—CH₂—CH₂

### Ring Structures

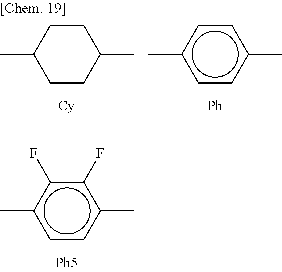

In the examples, the following properties were examined:

Tₙᵢ: nematic-isotropic liquid phase transition temperature (° C.)

Δn: refractive index anisotropy at 20° C.

Δ∈: dielectric anisotropy at 25° C.

η viscosity at 20° C. (mPa·s)

γ₁: rotational viscosity at 20° C. (mPa·s)

K₃₃: elastic constant K₃₃ at 20° C. (pN)

### Comparative Example 1 and Examples 1 to 4

Liquid Crystal Compositions LC-A (Comparative Example 1), LC-1 (Example 1), LC-2 (Example 2), LC-3 (Example 3), and LC-4 (Example 4) were prepared and examined for their physical properties. The compositions and physical properties of the liquid crystal compositions are summarized in Table 1.

TABLE 1

| | | Comparative | | | | |
|---|---|---|---|---|---|---|
| | | Example 1 | Example 1 | Example 2 | Example 3 | Example 4 |
| | | LC-A | LC-1 | LC-2 | LC-3 | LC-4 |
| 3-Ph-Ph-1 | general formula (III-F) | 10 | — | — | — | — |
| 1V2-Ph-Ph-3 | formula (I-B2) | — | 10 | — | — | — |
| V2-Ph-Ph-2V | formula (I-A4) | — | — | 10 | — | 5 |
| 1V2-Ph-Ph-2V1 | formula (I-B5) | — | — | — | 10 | 5 |
| 3-Cy-Cy-V | general formula (III-A) | 33 | 35 | 32 | 33 | 35 |
| 3-Cy-Cy-V1 | general formula (III-A) | — | — | 3 | 2 | — |
| 3-Cy-1O-Ph5-O2 | general formula (II-A1) | 9 | 11 | 8 | | 8 |
| 1V-Cy-1O-Ph5-O2 | general formula (II-A1) | — | — | 5 | 5 | 5 |
| 2-Cy-Cy-1O-Ph5-O2 | general formula (II-A3) | 13 | 12 | 11 | 11 | 11 |
| 3-Cy-Cy-1O-Ph5-O2 | general formula (II-A3) | 13 | 12 | 11 | 11 | 11 |
| 4-Cy-Cy-1O-Ph5-O2 | general formula (II-A3) | 4 | 3 | — | — | — |
| V-Cy-Cy-1O-Ph5-O2 | general formula (II-A3) | — | — | 3 | 3 | 3 |
| 3-Cy-Ph5-O2 | general formula (II-B1) | — | — | — | 4 | — |
| 3-Ph-Ph5-O2 | general formula (II-B2) | — | — | — | 4 | — |
| 3-Ph-Ph5-Ph-1 | general formula (V) | 9 | 8 | | | |
| 3-Ph-Ph5-Ph-2 | general formula (V) | 9 | 9 | 5 | 5 | 5 |
| V2-Ph-Ph5-Ph-2V | general formula (V) | — | — | 12 | 12 | 12 |
| Total | | 100 | 100 | 100 | 100 | 100 |
| Tni [° C.] | | 71.9 | 72.7 | 73.1 | 72.9 | 73.2 |
| Δn | | 0.114 | 0.114 | 0.115 | 0.115 | 0.115 |
| η [mPa · s] | | 14.8 | 13.7 | 13.2 | 13.2 | 13.1 |
| γ1 [mPa · s] | | 103 | 96 | 90 | 92 | 90 |
| Δε | | −3.2 | −3.2 | −3.2 | −3.1 | −3.2 |
| K33 [pN] | | 13.7 | 14.3 | 14.8 | 15.3 | 15.1 |
| γ1/K33 | | 7.5 | 6.7 | 6.1 | 6.0 | 6.0 |

Liquid Crystal Compositions LC-1, LC-2, LC-3, and LC-4 according to the present invention had low viscosities (η), low rotational viscosities (γ₁) and high elastic constants (K₃₃) and had significantly lower values of γ₁/K₃₃ than Liquid Crystal Composition LC-A of the comparative example, i.e., 6.7, 6.1, 6.0, and 6.0, respectively. Measurements of the response speed of liquid crystal display devices including these liquid crystal compositions showed that the devices including Liquid Crystal Compositions LC-1, LC-2, LC-3, and LC-4 had sufficiently high response speeds, i.e., about 10% to 20% higher response speeds than the device including Liquid Crystal Composition LC-A. Measurements of the voltage holding ratio (VHR) of the liquid crystal display devices showed that they had high VHR. The cell thickness was 3.5 μm. The alignment film was JALS2096. The response speed was measured at a Vₒₙ of 5.5 V, a V_{off} of 1.0 V, and a temperature of 20° C. using a DMS 301 instrument from Autronic-Melchers. The VHR was measured at a voltage of 5 V, a frequency of 60 Hz, and a temperature of 60° C. using a VHR-1 instrument from Toyo Corporation.

### Comparative Example 2 and Examples 5 to 7

Liquid Crystal Compositions LC-B (Comparative Example 2), LC-5 (Example 5), LC-6 (Example 6), and LC-7 (Example 7) were prepared and examined for their physical properties. The compositions and physical properties of the liquid crystal compositions are summarized in Table 2.

TABLE 2

| | | Comparative | | | |
|---|---|---|---|---|---|
| | | Example 2 | Example 5 | Example 6 | Example 7 |
| | | LC-B | LC-5 | LC-6 | LC-7 |
| 3-Ph-Ph-1 | general formula (III-F) | 10 | — | — | — |
| 1V2-Ph-Ph-3 | formula (I-B2) | — | 9 | — | |
| V2-Ph-Ph-2V | formula (I-A4) | — | — | 6 | 4 |
| 1V2-Ph-Ph-2V1 | formula (I-B5) | — | — | — | 4 |
| 3-Cy-Cy-V | general formula (III-A) | 29 | 30 | 33 | 29 |
| 3-Cy-Cy-V1 | general formula (III-A) | — | — | — | 2 |
| 3-Cy-Ph5-O2 | general formula (II-B1) | 4 | 6 | — | — |
| 3-Ph-Ph5-O2 | general formula (II-B2) | — | — | 6 | 6 |
| 2-Cy-Cy-Ph5-O2 | general formula (II-B3) | 11 | 10 | 10 | 11 |
| 3-Cy-Cy-Ph5-O2 | general formula (II-B3) | 11 | 10 | 10 | 11 |
| 4-Cy-Cy-Ph5-O2 | general formula (II-B3) | 11 | 10 | 10 | 11 |
| 3-Cy-Ph-Ph5-O2 | general formula (II-B4) | 6 | 7 | 7 | 6 |
| 3-Ph-Ph5-Ph-1 | general formula (V) | 9 | 9 | — | — |
| 3-Ph-Ph5-Ph-2 | general formula (V) | 9 | 9 | 9 | 7 |
| 1V2-Ph-Ph5-Ph-2V1 | general formula (V) | — | — | 9 | 9 |
| Total | | 100 | 100 | 100 | 100 |
| Tni [° C.] | | 79.2 | 80.4 | 81.8 | 81.7 |
| Δn | | 0.120 | 0.120 | 0.120 | 0.120 |
| η [mPa · s] | | 18.7 | 17.9 | 17.8 | 18.1 |
| γ1 [mPa · s] | | 106 | 98 | 95 | 99 |
| Δε | | −2.5 | −2.5 | −2.6 | −2.6 |
| K33 [pN] | | 13.1 | 13.4 | 13.8 | 14.1 |
| γ1/K33 | | 8.1 | 7.3 | 6.9 | 7.0 |

Liquid Crystal Compositions LC-5, LC-6, and LC-7 according to the present invention had low viscosities (η), low rotational viscosities (γ₁) and high elastic constants (K₃₃) and had significantly lower values of γ₁/K₃₃ than Liquid Crystal Composition LC-B of the comparative example, i.e., 7.3, 6.9, and 7.0, respectively. Measurements of the response speed of liquid crystal display devices including these liquid crystal compositions showed that the devices including Liquid Crystal Compositions LC-5, LC-6, and LC-7 had sufficiently high response speeds, i.e., not less than 10% higher response speeds than the device including Liquid Crystal Composition LC-B. Measurements of the voltage holding ratio (VHR) of the liquid crystal display devices showed that they had high VHR. The cell thickness was 3.5 μm. The alignment film was JALS2096. The response speed was measured at a Vₒₙ of 5.5 V, a V_{off} of 1.0 V, and a temperature of 20° C. using a DMS 301 instrument from Autronic-Melchers. The VHR was measured at a voltage of 5 V, a frequency of 60 Hz, and a temperature of 60° C. using a VHR-1 instrument from Toyo Corporation.

The above results demonstrate that the present invention provides a liquid crystal composition with sufficiently low viscosity (η), sufficiently low rotational viscosity (γ₁), high elastic constant (K₃₃), and a negative dielectric anisotropy (Δ∈) large in absolute value without decreasing the refractive index anisotropy (Δn) or nematic-isotropic liquid phase transition temperature (Tₙᵢ) thereof. The results also demonstrate that a VA-mode liquid crystal display device including such a liquid crystal composition has high response speed and good display quality.

### Comparative Example 3 and Examples 8 to 10

Liquid Crystal Compositions LC-C(Comparative Example 3), LC-8 (Example 8), LC-9 (Example 9), and LC-10 (Example 10) were prepared and examined for their physical properties. The compositions and physical properties of the liquid crystal compositions are summarized in Table 3.

TABLE 3

| | | Comparative | | | |
|---|---|---|---|---|---|
| | | Example 3 | Example 8 | Example 9 | Example 10 |
| | | LC-C | LC-8 | LC-9 | LC-10 |
| 3-Ph-Ph-1 | general formula (III-F) | 5 | — | — | — |
| 1V2-Ph-Ph-1 | general formula (I-B6) | — | — | 5 | 5 |
| V2-Ph-Ph-1 | general formula (I-A5) | — | 5 | 5 | 5 |
| 3-Cy-Cy-V | general formula (III-A) | 34 | 39 | 34 | 34 |
| 3-Cy-Cy-V1 | general formula (III-A) | — | — | — | 3 |
| 3-Cy-1O-Ph5-O2 | general formula (II-A1) | — | 4 | 4 | 3 |
| 2-Cy-Cy-1O-Ph5-O2 | general formula (II-A3) | — | 11 | 11 | 11 |
| 3-Cy-Cy-1O-Ph5-O1 | general formula (II-A3) | — | 11 | 11 | 11 |
| 3-Cy-Cy-1O-Ph5-O2 | general formula (II-A3) | — | 6 | 6 | 4 |
| 3-Cy-Ph5-O2 | general formula (II-B1) | 4 | — | — | — |
| 5-Ph-Ph5-O2 | general formula (II-B2) | — | — | — | 4 |
| 2-Cy-Cy-Ph5-O1 | general formula (II-B3) | 11 | — | — | — |
| 2-Cy-Cy-Ph5-O2 | general formula (II-B3) | 11 | — | — | 4 |
| 2-Cy-Cy-Ph5-O3 | general formula (II-B3) | 11 | — | — | — |
| 2-Cy-Ph-Ph5-O2 | general formula (II-B4) | 6 | 6 | 6 | 6 |
| 3-Ph-Ph5-Ph-1 | general formula (V) | 9 | 9 | 9 | — |
| 3-Ph-Ph5-Ph-2 | general formula (V) | 9 | 9 | 9 | — |
| V2-Ph-Ph5-Ph-2V | general formula (V) | — | — | — | 5 |
| 1V2-Ph-Ph5-Ph-2V1 | general formula (V) | — | — | — | 5 |
| Total | | 100 | 100 | 100 | 100 |
| Tni [° C.] | | 83.1 | 83.1 | 85.2 | 83.5 |
| ne | | 1.604 | 1.601 | 1.609 | 1.604 |
| no | | 1.490 | 1.487 | 1.490 | 1.490 |
| Δn | | 0.114 | 0.114 | 0.119 | 0.114 |
| η [mPa · s] | | 18.2 | 14.8 | 16.3 | 15.5 |
| γ1 [mPa · s] | | 113 | 92 | 101 | 96 |
| ε\|\| | | 3.3 | 3.4 | 3.4 | 3.4 |
| ε⊥ | | 5.8 | 6.3 | 6.3 | 6.1 |
| Δε | | −2.5 | −2.9 | −2.9 | −2.7 |
| K11 [pN] | | 15.1 | 16.0 | 16 | 15.5 |
| K33 [pN] | | 13.2 | 15.1 | 15.3 | 15.1 |
| γ1/K33 | | 8.6 | 6.1 | 6.6 | 6.4 |

Liquid Crystal Compositions LC-8, LC-9, and LC-10 according to the present invention had low viscosities (IV, low rotational viscosities (γ₁), and high elastic constants (K₃₃) and had significantly lower values of γ₁/K₃₃ than Liquid Crystal Composition LC-C of Comparative Example 3, i.e., 6.1, 6.6, and 6.4, respectively. Measurements of the response speed of liquid crystal display devices including these liquid crystal compositions showed that Liquid Crystal Compositions LC-8, LC-9, and LC-10 had sufficiently high response speeds, i.e., about 20% to 30% higher response speeds than Liquid Crystal Composition LC-C. Measurements of the voltage holding ratio (VHR) of the liquid crystal display devices showed that they had high VHR. The cell thickness was 3.5 μm. The alignment film was JALS2096. The response speed was measured at a Vₒₙ of 5.5 V, a V_{off} of 1.0 V, and a temperature of 20° C. using a DMS 301 instrument from Autronic-Melchers. The VHR was measured at a voltage of 5 V, a frequency of 60 Hz, and a temperature of 60° C. using a VHR-1 instrument from Toyo Corporation.

The above results demonstrate that the present invention provides a liquid crystal composition with sufficiently low viscosity (η), sufficiently low rotational viscosity (γ₁), a high elastic constant (K₃₃), and a negative dielectric anisotropy (Δ∈) large in absolute value without decreasing the refractive index anisotropy (Δn) or nematic-isotropic liquid phase transition temperature (Tₙᵢ) thereof. The results also demonstrate that a VA-mode liquid crystal display device including such a liquid crystal composition has high response speed and good display quality.

1. A liquid crystal composition comprising a first component and a second component, the first component comprising at least one compound represented by general formula (I): 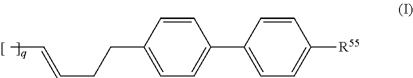
(wherein q is 0 or 1, and R⁵⁵ is an alkyl group having 1 to 10 carbon atoms or an alkenyl group having 2 to 10 carbon atoms), the first component being present in an amount of 3% to 25% by mass, the second component comprising a compound having a negative dielectric anisotropy (Δ∈) larger than 3 in absolute value.

2. The liquid crystal composition according to claim 1, wherein the liquid crystal composition has a dielectric anisotropy (Δ∈) at 25° C. of −2.0 to −8.0, a refractive index anisotropy (Δn) at 20° C. of 0.08 to 0.14, a viscosity (η) at 20° C. of 10 to 30 mPa·s, a rotational viscosity (γ₁) at 20° C. of 60 to 130 mPa·s, and a nematic-isotropic liquid phase transition temperature (Tₙᵢ) of 60° C. to 120° C.

3. The liquid crystal composition according to claim 1, wherein the second component comprises at least one compound selected from the group consisting of compounds represented by general formula (II): 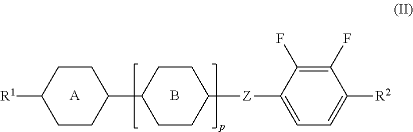
(wherein R¹ and R² are each independently an alkyl group having 1 to 10 carbon atoms, an alkoxyl group having 1 to 10 carbon atoms, an alkenyl group having 2 to 10 carbon atoms, or an alkenyloxy group having 2 to 10 carbon atoms, wherein one or more separate —CH₂— groups present in R¹ and R² are each independently optionally replaced by —O— and/or —S—, and one or more hydrogen atoms present in R¹ and R² are each independently optionally replaced by a fluorine atom or a chlorine atom; rings A and B are each independently trans-1,4-cyclohexylene, 1,4-phenylene, 2-fluoro-1,4-phenylene, 3-fluoro-1,4-phenylene, 3,5-difluoro-1,4-phenylene, 2,3-difluoro-1,4-phenylene, 1,4-cyclohexenylene, 1,4-bicyclo[2.2.2]octylene, piperidine-1,4-diyl, naphthalene-2,6-diyl, decahydronaphthalene-2,6-diyl, or 1,2,3,4-tetrahydronaphthalene-2,6-diyl; p is 0, 1, or 2; and Z is —OCH₂—, —CH₂O—, —CF₂O—, —OCF₂—, —CH₂CH₂—, —CF₂CF₂—, or a single bond).

4. The liquid crystal composition according to claim 1, wherein the second component is present in an amount of 10% to 90% by mass.

5. The liquid crystal composition according to claim 3, wherein the compounds of general formula (II) for the second component have general formulae (II-A1) to (II-A5) and (II-B1) to (II-B5): 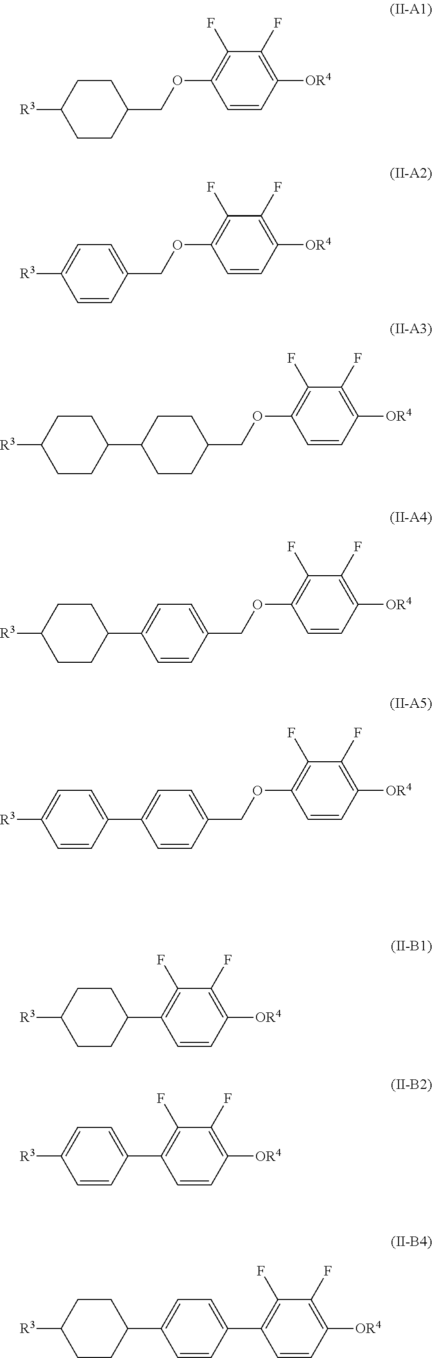 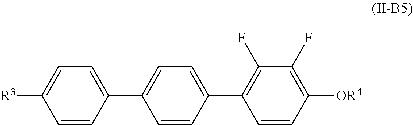
(wherein R³ and R⁴ are each independently an alkyl group having 1 to 5 carbon atoms or an alkenyl group having 2 to 5 carbon atoms, wherein one or more hydrogen atoms present in R³ and R⁴ are each independently optionally replaced by a fluorine atom).

6. The liquid crystal composition according to claim 5, wherein the second component comprises at least one compound selected from the group consisting of compounds represented by general formulae (II-A1) to (II-A5).

7. The liquid crystal composition according to claim 1, wherein the compound of general formula (I) is represented by any of formulae (I-A1), (I-A2), (I-A3), (I-A4), (I-B1), (I-B2), (I-B3), (I-B4), and (I-B5):

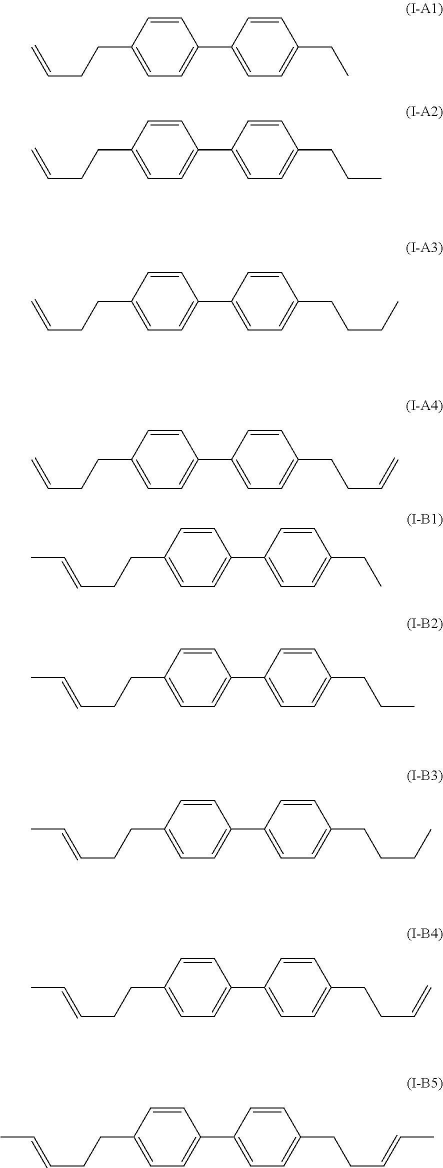

8. The liquid crystal composition according to claim 1, further comprising a third component, the third component comprising at least one compound selected from the group consisting of compounds represented by general formulae (M-A) to (III-J): 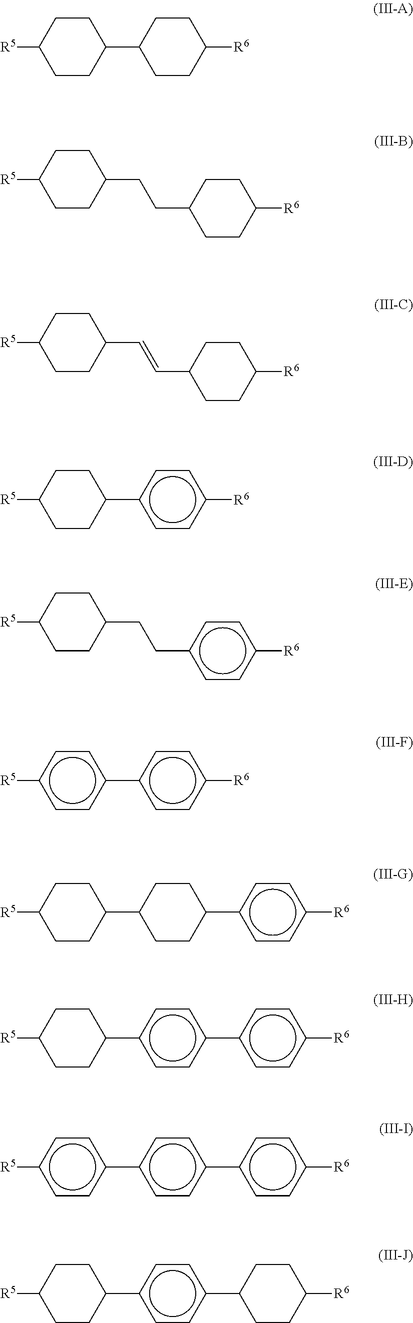
(wherein R⁵ is an alkyl group having 1 to 5 carbon atoms or an alkenyl group having 2 to 5 carbon atoms; and R⁶ is an alkyl group having 1 to 5 carbon atoms, an alkoxyl group having 1 to 5 carbon atoms, an alkenyl group having 2 to 5 carbon atoms, or an alkenyloxy group having 2 to 5 carbon atoms, wherein the compounds represented by general formula (III-F) exclude compounds represented by general formula (I)).

9. The liquid crystal composition according to claim 8, wherein the liquid crystal composition simultaneously comprises compounds of general formulae (I), (II-A1), and (III-A).

10. The liquid crystal composition according to claim 8, wherein the liquid crystal composition simultaneously comprises compounds of general formulae (I), (II-A3), and (III-A).

11. The liquid crystal composition according to claim 8, wherein the liquid crystal composition simultaneously comprises compounds of general formulae (I), (II-B1), and (III-A).

12. The liquid crystal composition according to claim 8, wherein the liquid crystal composition simultaneously comprises compounds of general formulae (I), (II-B2), and (III-A).

13. The liquid crystal composition according to claim 8, wherein the liquid crystal composition simultaneously comprises compounds of general formulae (I), (II-B3), and (III-A).

14. The liquid crystal composition according to claim 8, wherein the liquid crystal composition simultaneously comprises compounds of general formulae (I), (II-B4), and (III-A).

15. The liquid crystal composition according to claim 1, further comprising at least one compound represented by general formula (V): 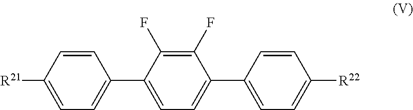
(wherein R²¹ and R²² are each independently an alkyl group having 1 to 8 carbon atoms, an alkoxyl group having 1 to 8 carbon atoms, an alkenyl group having 2 to 8 carbon atoms, or an alkenyloxyl group having 2 to 8 carbon atoms).

16. The liquid crystal composition according to claim 1, further comprising at least one polymerizable compound.

17. The liquid crystal composition according to claim 16, wherein the polymerizable compound has general formula (IV): 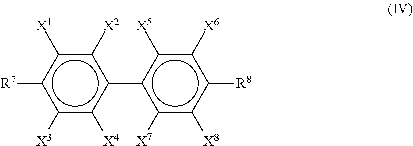
(wherein R⁷ and R⁸ are each independently represented by any of formulae (R-1) to (R-15): 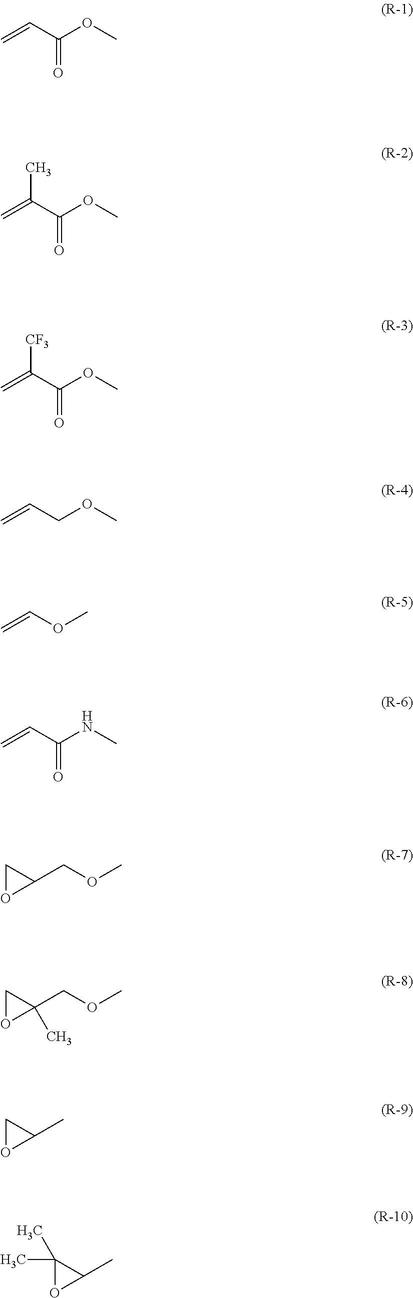 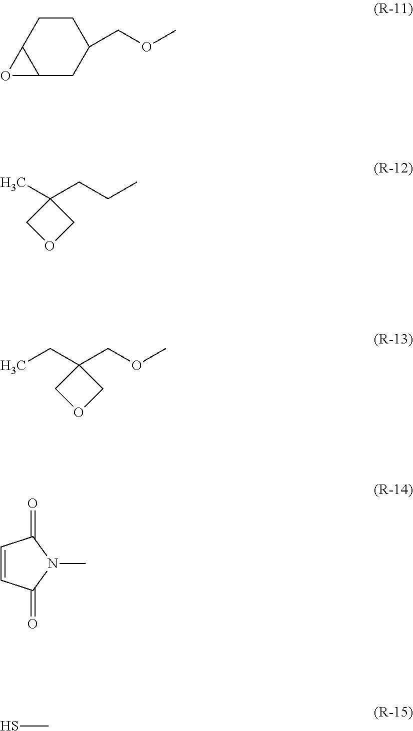
and X¹ to X⁸ are each independently trifluoromethyl, trifluoromethoxy, fluorine, or hydrogen).

18. A liquid crystal display device comprising the liquid crystal composition according to claim 1.

19. An active-matrix liquid crystal display device comprising the liquid crystal composition according to claim 1.

20. A VA-mode, PSA-mode, PSVA-mode, IPS-mode, or ECB-mode liquid crystal display device comprising the liquid crystal composition according to claim 1.
